(19) United States
(12) Patent Application Publication
(10) Pub. No.: US 2002/0135610 A1
(43) Pub. Date: Sep. 26, 2002

(54) Visualization of multi-layer network topology

(75) Inventors: Toshio Ootani, Fujisawa (JP); Eiji Ohira, Hamura (JP); Katsuyoshi Kitai, Inagi (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd.

(21) Appl. No.: 09/920,921

(22) Filed: Aug. 3, 2001

(30) Foreign Application Priority Data
Mar. 23, 2001 (JP) 2001-084514

(51) Int. Cl. G06F 3/14

(52) U.S. Cl. 345/734

(57) ABSTRACT

A system and method for visualizing multi-layer topology schematics from topology data, enabling view level (layer) change to an alternative view level (layer) by selecting a partial domain on the schematic displayed on the screen. The system may include: view level tables corresponding to all partial domains set in accordance with the arrangement of components in a topology schematic space, wherein each component to be visualized within a partial domain and the view levels of the components are defined. In response to an input whereby a partial domain and a specific view level to which the currently visualized schematic is to change have been selected, the system determines one or more components belonging to the selected view level from the view table for the specified partial domain and visualizes the component(s) within the selected domain.

### PRIORITY TO FOREIGN APPLICATIONS

This application claims priority to Japanese Patent Application No. P2001-084514.

### BACKGROUND OF THE INVENTION

1. Field of the Invention

The present invention relates to systems and methods for visualizing multi-layer topology schematics from topology data, and more specifically, the present invention relates to systems and methods for visualizing topology schematics on multiple layers from topology data such as communication network topologies, wherein components to be shown, the degree of detail, and component-to-component connections may be different for each layer, the system enabling presentation of a desired layer topology by selecting a view level corresponding to the layer.

2. Description of the Background

In a support system for designing and operating a communication network comprising a great number of networking equipment units, the scope and the degree of detail of topology schematics to be visualized on a terminal screen may differ according to an operator's intended purpose. Particularly, if working with multi-layer topology schematics such as communication network topologies, wherein components to be shown or component-to-component connections may be different for each view level, functionality is desired to enable a user to select a domain on the currently displayed schematic and choose a specific level to which the selected domain is preferably changed on the display.

It should be noted at the outset that the terms “visualize” and “display” are used interchangeably throughout this specification. As used herein, the terms “visualization” or “to visualize” refer to both the physical act of displaying a topology or other diagram on a computer screen or display as well as the more abstract concept of turning a series of components and connections into a topology diagram in the first place. The term “display” is used in its conventional sense to mean the physical act of displaying a topology or other diagram for a user.

Methods relevant to topology visualization are disclosed in, for example, JP-A-Nos. 340129/1992 and 266249/1992. According to these references, to enable a stepwise view level change from outline views to more detailed views, hierarchically developed network topology schematics are managed in accordance with parent-child relationships represented by a tree structure. When a schematic on a certain layer is displayed and the user requests a change to a more detailed view, a schematic one layer lower (a “child” to the currently displayed schematic in the parent-child relationship) is typically displayed.

For the conventional method of view level changeover between multi-layer topology schematics in accordance with parent-child relationships represented by a tree structure, the changeover is limited to that which follows the hierarchical order of layers. These systems are not capable of changing the currently displayed schematic from one layer to another randomly selected layer. Furthermore, it may be difficult to perform view level changeover from layer to layer whose parent-child relationship cannot be defined in the tree structure; e.g., changeover between physical layer and IP (Internet Protocol) layer in the communication network.

In conventional multi-layer topology schematics, layer or level data for component-to-component connections is not typically taken into consideration. This limitation may cause the following problem. When a plurality of components belonging to different layers are displayed on the screen, identification of the layer to which each of the circuits interconnecting the components belongs is vague, and the user cannot easily determine the meaning of the connecting circuits.

In these multi-layer topology schematics, when the user selects a specific component on the currently displayed schematic and a specific view level to which the schematic is to be changed, a partial topology schematic from the selected view level replaces the symbol of the specific component and is displayed on the screen. According to the conventional technique, if the newly displayed partial topology schematic comprises a plurality of components, the user may not be able to determine the correspondence between the preceding symbol (which has been erased from the screen) and the group of the newly displayed symbol(s).

During the display of a communication network topology schematic, assume that the view of a circuit (IP logical circuit) shown on the IP layer changes to the physical layer view. Due to this change, when a physical connecting net consisting of a plurality of paths is newly displayed on the screen, the user cannot promptly determine the path in the physical connecting net to which the IP logical circuit shown on the preceding display image corresponds.

### SUMMARY OF THE INVENTION

In at least one preferred embodiment, the present invention provides a method, system, and computer program for visualizing multi-layer topology schematics from topology data to enable simplified view level (layer) change to another optional view level (layer) by selecting a partial domain on the schematic displayed on the screen. The invention may also allow the user to easily recognize the layer to which each of the circuits interconnecting the components belongs.

The present invention preferably also provides a method, system, and computer program for visualizing multi-layer topology schematics from topology data, that allows the user to easily recognize the correspondence between a component shown on the display screen before view level change and a component or a group of components newly shown after the change (and vice versa).

The invention manages component data for multi-layer topology schematics in units of partial domains which are set in accordance with the arrangement on schematic or function of the components.

More specifically, a system for visualizing multi-layer topology schematics from topology data of the present invention preferably comprises visualization control means and partial domain management units, wherein one or more units are prepared for each partial domain set in accordance with the arrangement of the components in the topology schematic space or the function of each component. In each of the above partial domain management units, components to be visualized within the domain and the view levels of the components are preferably predefined.

In response to input by which a partial domain and a specific level to which the currently visualized schematic is to change have been selected (e.g., by selecting with a computer mouse), the visualization control means sets the specific level in the partial domain management unit for controlling the partial domain selected. Consequently, the system displays the component(s) on the specific level as defined in the partial domain management unit within the partial domain selected.

The present invention may also display the components on a specific view level as defined in the above partial domain management units for all partial domains on the display screen. The invention preferably does not set a plurality of topology schematics for different view levels in order-based relationship or parent-child relationship represented by a tree structure, as does the conventional method.

In addition, the present invention manages a connecting circuit as a component (for both physical and logical circuits) that interconnects a component included in one partial domain and another component included in another partial domain. This interconnecting component and its view level are preferably defined in a specific partial domain management unit.

If interconnected, two partial domains are visualized on the same view level, a domain-interconnecting circuit belonging to this level is also shown as defined in the partial domain management unit for connecting circuits. If the two partial domains are displayed on different levels due to view level change, priority is given to the preceding view level of the circuit with respect to the connecting circuit. Even on the newly displayed image, the connecting circuit of the same level as in the preceding display image is shown, so that the user can easily understand the view level of the connecting circuit.

In accordance with the present invention, in each of the partial domain management units, domain coordinates settings and domain size settings that may be different for each view level are predefined. When a view level is selected as the one to which the view of a partial domain is to change, the present invention visualizes the component(s) on the selected view level within a view domain determined by the above domain coordinates and size settings. Moreover, for all components included in the multi-layer topology schematics, the coordinates where a component is to be visualized within the partial domain and the component symbol figure are predefined.

The invention displays the symbol figure(s) corresponding to the component(s) on the selected view level in a position determined by the above coordinates within the view domain. In accordance with a preferred embodiment of the present invention, the visualization control means compares the above domain size settings before and after view level change and automatically modifies the coordinates of other partial domains to be displayed on the schematic, according to the results of the comparison.

The foregoing system may also include a components connection table in which component-to-component connections included in multi-layer topology schematics are defined as discrete component-to-component links independent of the view level to which each component belongs. When a view level change in the selected partial domain takes place, the visualization control means visualizes connection lines between the newly displayed component(s) within the domain and the existing components on the display screen in accordance with said components connection table.

The system of the present invention preferably includes an interlayer relation table in which distinct correspondence of a specific component on a view level to at least one component on another view level is defined. When the specific component is erased as its view level changes to another level and the corresponding component on another level as defined in the interlayer relation table is newly visualized, the visualization control means displays the component on another level in a prominent visual style, for example, highlighting the component in bold or a different color.

In accordance with the present invention, a method for visualizing multi-layer topology schematics from topology data is also provided. This method may be characterized in that, in response to a request from a terminal user, a server sends multi-layer topology data to the terminal device across a network, and the terminal device creates view level tables for partial domains in accordance with the received multi-layer topology data. The foregoing domain coordinates settings and domain size settings that may be different for each view level for all partial domains, the coordinates where a component is to be visualized within the partial domain, the component symbol figure for all components, the component-to-component connections, and the interlayer relation of a specific component to its corresponding component(s) are all preferably predefined in the multi-layer topology data sent from the server to the terminal device.

The features of a method, system, and computer program for visualizing multi-layer topology schematics from topology data in accordance with the present invention will be made more clear from the detailed description of the invention, the attached drawings and the claims that follow.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows the overall configuration of a communication network topology data management support system to which the present invention is applied;

FIG. 2 illustrates an exemplary communication procedure to be carried out between the server and terminals shown in FIG. 1;

FIG. 3 illustrates an exemplary options menu window which is displayed on the screen of a terminal device;

FIG. 4 shows an area layer network topology schematic example displayed on the terminal screen;

FIG. 5 shows a network topology schematic display image example of physical layer representation of a part of the area layer;

FIG. 6 shows a network topology schematic display image example of IP layer representation of area-to-area connection;

FIG. 7 shows a network topology schematic display image example representing area-to-area connection;

FIG. 8 shows a network topology schematic display image example of physical layer representation of the areas and interconnection of areas shown in FIG. 7;

FIG. 9 is a diagram for explaining the communication network topology data structure in the present invention;

FIG. 10 shows part of exemplary descriptions of network component definitions stored in an XML data file of the present invention;

FIG. 11 continues the exemplary descriptions of FIG. 10;

FIG. 12 shows part of exemplary descriptions of LOVD instance definitions stored in the above XML data file;

FIG. 13 continues the exemplary descriptions of FIG. 12;

FIG. 14 shows part of exemplary descriptions of components interconnection definitions stored in the above XML data file;

FIG. 15 shows part of exemplary descriptions of specific component interlayer relation definitions stored in the above XML data file;

FIG. 16 is a diagram showing the functional structure of an applet that is activated on each terminal in a first exemplary embodiment of the invention;

FIG. 17 is a flowchart illustrating the operation of a visualization management function of the above applet;

FIG. 18 shows an exemplary connection table;

FIG. 19 shows an exemplary interlayer relation table;

FIG. 20 shows the structure of a LOVD instance created by the visualization management function;

FIG. 21 shows an exemplary view level table attached to the LOVD instance;

FIG. 22 shows an exemplary view size table attached to the LOVD instance;

FIG. 23 illustrates exemplary visualization management function operation;

FIG. 24 shows an exemplary pop-up window for selecting a partial domain layer;

FIG. 25 illustrates the details of LOVD coordinates calculation;

FIG. 26 shows an exemplary physical layer topology schematic displayed on a terminal screen in accordance with the present invention;

FIG. 27 is a diagram for explaining data structure for a system for visualizing schematics from electronic circuit data in accordance with the invention;

FIG. 28 is a logical layer schematic display image example presented by the above system for visualizing schematics from electronic circuit data;

FIG. 29 is a display image example with part of the above logical layer schematic changed to circuit layer representation; and

FIG. 30 is a display image example with part of the above logical layer schematic changed to cell layer representation.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, other elements that may be well known. Those of ordinary skill in the art will recognize that other elements are desirable and/or required in order to implement the present invention. However, because such elements are well known in the art, and because they do not facilitate a better understanding of the present invention, a discussion of such elements is not provided herein. The detailed description will be provided hereinbelow with reference to the attached drawings.

To better understand preferred embodiments of the invention, an exemplary communication network topology data management support system will initially be discussed in which a system for visualizing multi-layer topology schematics from topology data in accordance with the present invention is embodied.

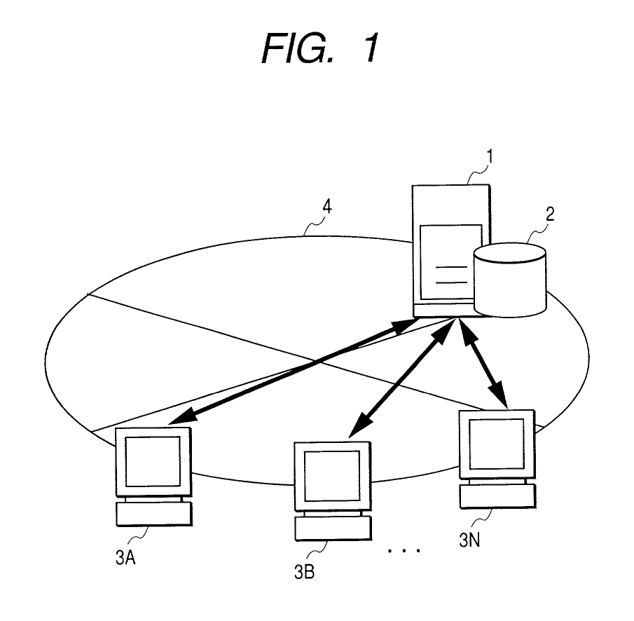

As shown in FIG. 1, a communication network topology data management support system according to one embodiment of the invention preferably comprises a server 1 equipped with a database 2 and a plurality of terminals 3 (3A to 3N), each equipped with a WWW (World Wide Web) browser. These terminals 3 are connected to the server 1 via a network 4 (for example, the Internet) The server 1 preferably retains the topology data for communication networks in the design phase and communication networks to be monitored or in operation in its database 2 and offers the communication network topology data to the terminals 3.

The server 1 preferably manages the above communication network topology data divided into multiple different layers of hierarchy. The layers of network data may include, for example: an area layer topology that represents area-to-area connections of organization-level areas such as the geographically distributed areas where a head office and branches exist discretely; a physical layer topology that represents physical connections of networking hardware units and physical circuits constituting the practical communication network; and an IP layer topology that represents logical connections of network components on the IP (Internet Protocol) layer provided in the OSI protocol hierarchy model.

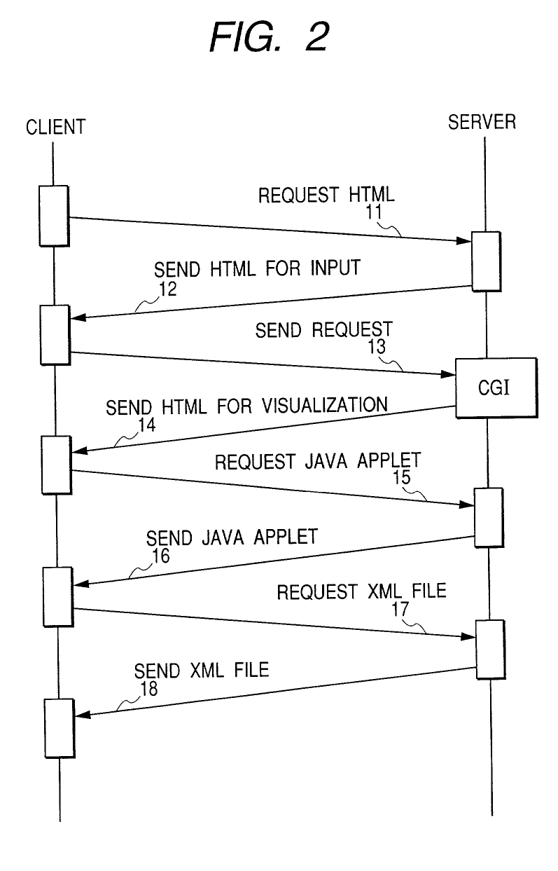

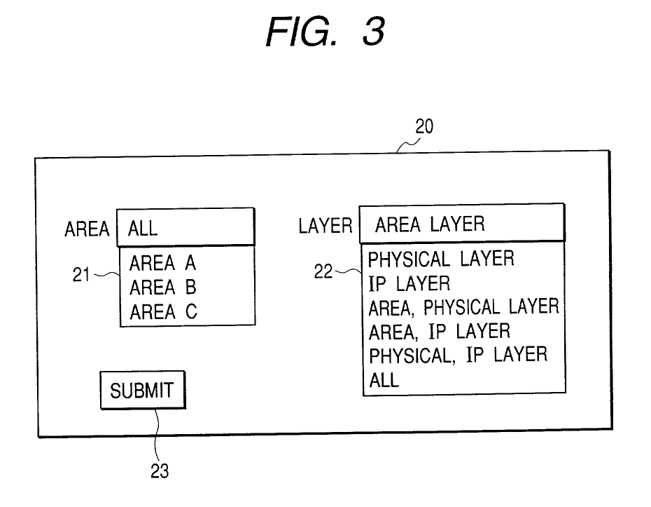

FIG. 2 shows an exemplary communication procedure to be carried out between the above server 1 and the terminals (client) 3. A user at a terminal 3 in need of communication network topology data attempts to access an HTML (Hyper Text Markup Language) file through the WWW browser window (request HTML 11). In response to the request for the HTML file 11, the server 1 sends an HTML file for input to the terminal 3 (12), and an options menu window for selecting desired communication network topology data is displayed on the WWW browser window. The options menu window consists of, for example, an area options menu 21, a layer options menu 22, and the “submit” button 23, as is shown in FIG. 3. In this example, it is assumed that the user selected “All” from the area options menu 21 and “Area Layer” from the area options menu 22, and selected (clicked with a mouse) the submit button 23.

When the user selects a desired area and presses the submit button 23, a topology data request message is sent to the server 1 (13). In response to the request, the server 1 retrieves communication network topology data as selected by the user from the database 2, converts this data to an XML (extensible Markup Language) file, and sends an HTML file for visualization back to the terminal (14). Such communication processing is preferably performed in a conventional method using CGI (Common Gateway Interface) between a Web server and a client.

In the HTML file for visualization, the XML file name is described and the name of a JAVA applet is described which is a program for visualizing the XML file contents on the screen of the terminal. When the terminal receives the HTML file, the JAVA applet name is preferably shown on the terminal screen. When the user selects the JAVA applet name, a request for the JAVA applet (15) is sent to the server 1 and the server 1 sends the JAVA applet back to the terminal (16). When the user selects the XML file name on the terminal screen, a request for XML file is sent to the server 1 (17) and the server 1 sends the XML file back to the terminal (18). The XML file is read by the JAVA applet activated on the WWW browser, which will be explained later, and its contents, the user-desired network topology data is displayed on the WWW browser window.

It should be noted that the above file types (XML, HTML), programs (JAVA applets) and communications protocols (CGI) are offered by way of example, and other conventional types and orientations of these components may be used within the scope of the present invention. For example, some or all of the above information existing on the server may reside instead or additionally on the terminal or other client device.

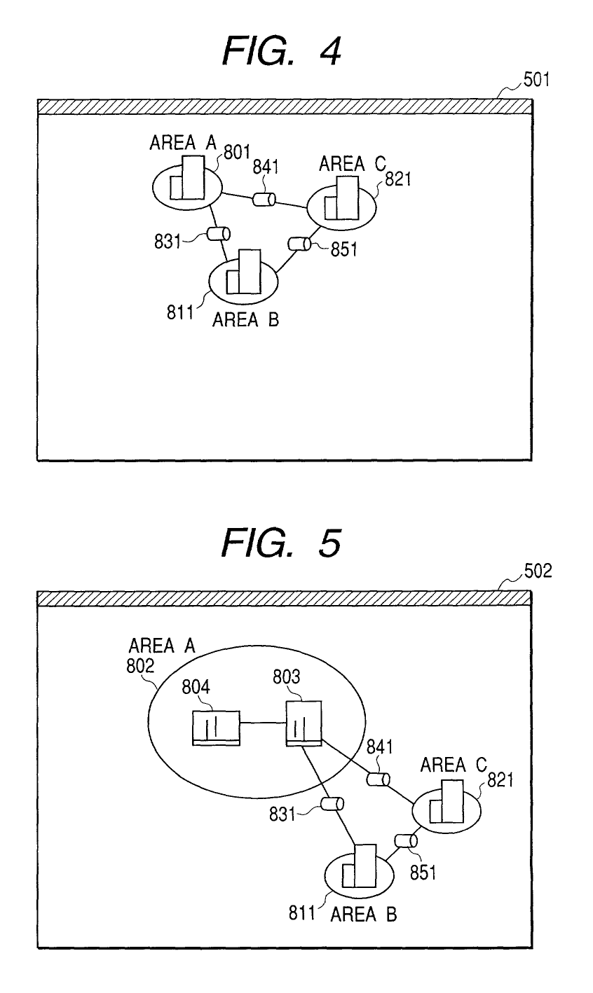

FIGS. 4 to 6 show display images of network topology schematic examples visualized in the display area (or window) on the terminal screen.

FIG. 4 is an area layer topology schematic display image 501 wherein area A 801, area B 811, area C 821, and physical circuits 831, 841, and 851 interconnecting these areas are depicted as the components.

FIG. 5 is a physical layer topology schematic display image 502 showing a detailed view of the area A 801 in the above area layer topology schematic, wherein the area A is depicted as a FIG. 802 containing a router 804 and an ATM switch 803.

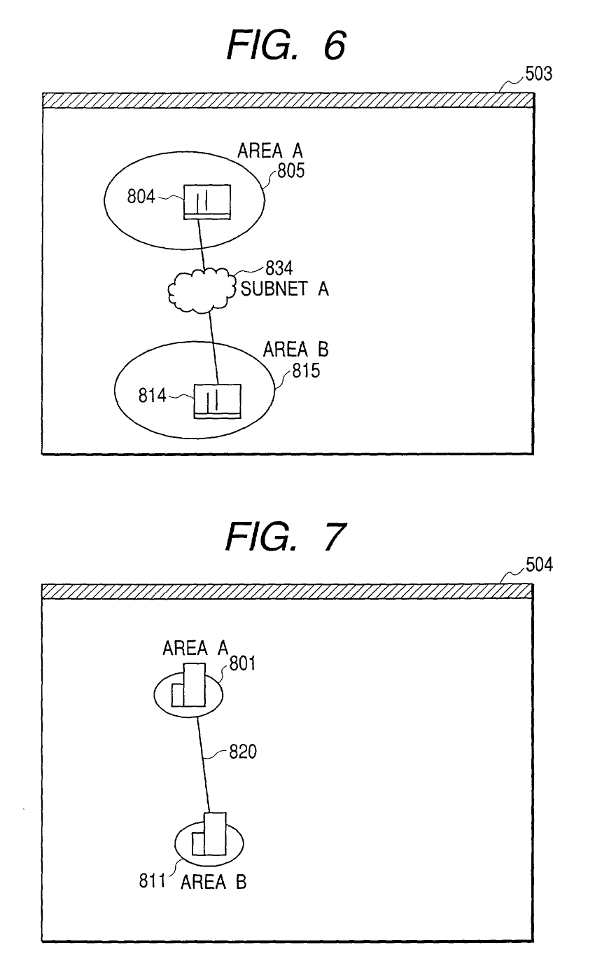

FIG. 6 is an IP layer topology schematic display image 503 wherein the connection between the area A 801 and the area B 811 in the area layer topology schematic is depicted. The area A is depicted as a symbolic FIG. 805 containing the symbolic representation of a router 804. The area B is depicted as a symbolic FIG. 815 containing the symbolic representation of a router 814. These routers are connected via a subnet A 834.

According to the conventional network topology data management, the data for the topology schematics of different hierarchical layers as shown in FIGS. 4 to 6 would be managed by means of the tree structure concept. View levels corresponding to the layers should be positioned in parent-child relationship or order-based relationship. For example, if the area layer topology schematic shown in FIG. 4 is assumed a parent layer, the physical layer topology schematic shown in FIG. 5 and the IP layer topology schematic shown in FIG. 6 should be defined as child layers of the area layer topology schematic.

In this case, a change from the area layer topology schematic of FIG. 4 to the physical layer topology schematic of FIG. 5 or the IP layer topology schematic of FIG. 6 could easily be performed by using the predefined parent-child relationship. However, it would be difficult to perform a prompt view state changeover between those schematics that are independent of parent-child relationship or order-based relationship. For example, a change between the physical layer topology schematic of FIG. 5 and the IP layer topology schematic of FIG. 6 would be difficult because the user needs to return to the area layer to make view state change from one of these schematics to another.

Furthermore, for the conventional communication network topology data management, for example, in the network topology schematic of FIG. 5, if some component (area A 802) is displayed on a view level different from the view level for other components (area B 811 and area C 821), it would be difficult for the user to precisely determine the meaning of the connecting circuits shown. Because the representation of the connecting circuits corresponding to the component-to-component connections lacks the concept of view levels, the connecting circuit does not aid in the desired understanding.

A schematic display image 504 shown in FIG. 7 where area A 801 and area B 811 interconnect will now be referenced. Here, a circuit 820 interconnecting area A 801 and area B 811 may be either a physical circuit or an IP logical circuit. However, because no information about the view level of the connecting circuit is provided, the circuit definition is vague and the user cannot (easily) distinguish between the physical circuit and IP logical circuit.

Furthermore, for the conventional type of communication network topology data management, when the view level of network topology data visualization changes, the contents of the schematic display images before and after the change are independent of each other. Consequently, the user may not be able to understand the correspondence between the components of the preceding display image and the components of the new display image.

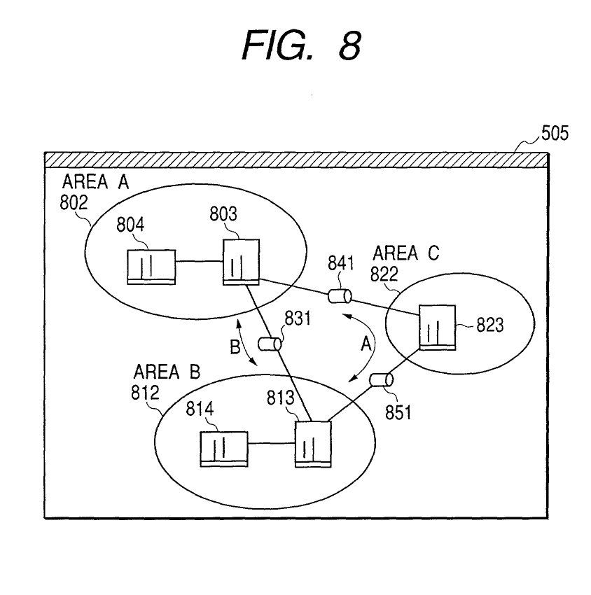

This problem will be illustrated below, using FIG. 6 and FIG. 8 as examples. In the schematic display image 503 of FIG. 6, the path from the router 804 to the router 814 is formed by the router 804, subnet A 834 (IP logic circuit), and router 814. On the other hand, FIG. 8 shows a physical layer topology schematic display image 505 covering all areas in FIG. 4. In the schematic display image of FIG. 8, two physical paths from the router 804 in area A to the router 814 in area B exist. One path is path A passing through ATM switch 803, physical circuit 841, ATM switch 823, physical circuit 851, and ATM switch 813. The other path is path B passing through ATM switch 803, physical circuit 831, and ATM switch 813.

If it is assumed that the schematic display image 503 changes to the schematic display image 505, the user cannot determine which of the paths A and B on the new display image 505 that corresponds to the subnet A 834 existed on the preceding display image. For determination, the user needs to refer to other data which decreases working efficiency.

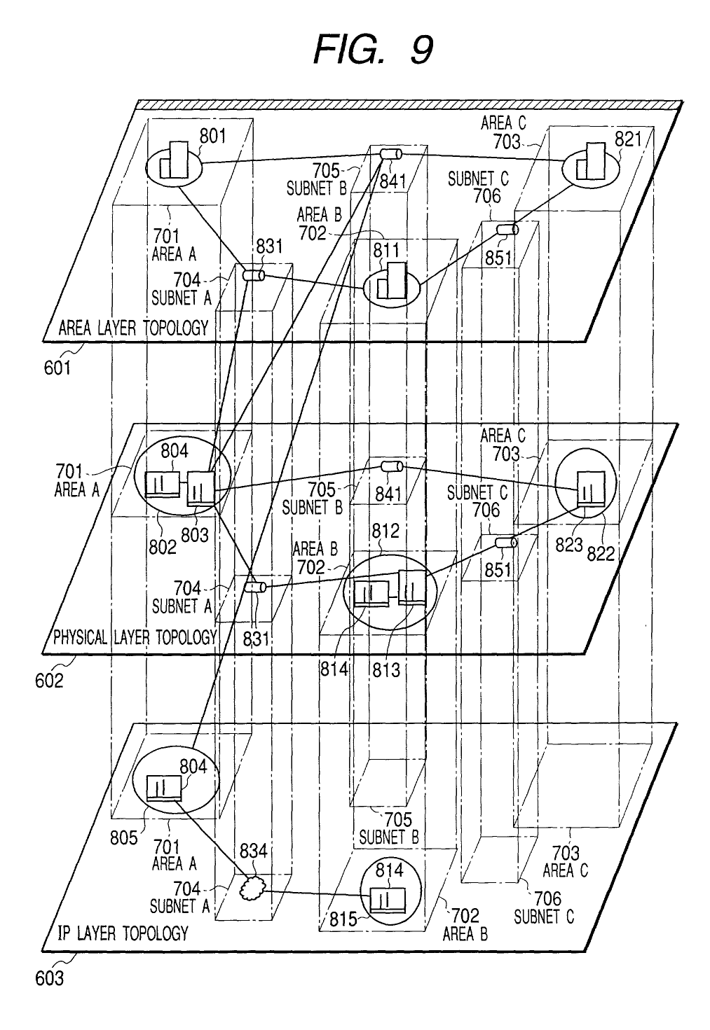

To address one or more of the above limitations of the conventional systems, the visualization system of the present invention preferably manages network topology data stored in the database 2 in two aspects: management on a layer-by-layer basis, for example, using a set of parallelograms 601 to 603 in the abscissa direction shown in FIG. 9; and management in partial domain space units, for example, using a set of domains 701 to 706, each square delimited by dotted line boundaries, extending in the ordinate direction, shown in FIG. 9.

Data representing communication network components such as areas, networking equipment units, and circuits is classified into layers in accordance with the communication protocol and managed. In FIG. 9, the data is classified into three layers 601, 602, and 603. The first layer 601 is area layer topology data that defines area A 801, area B 811, area C 821, and physical circuits 831, 841, and 851 interconnecting the areas. The second layer 602 is physical layer topology data that defines router 804, ATM switch 803, router 814, ATM switches 813 and 823, and physical circuits 831, 841, 851 interconnecting these routers and switches. The third layer 603 is IP layer topology data that defines routers 804 and 814, and subnet A 834 (IP logical circuit) interconnecting these routers.

On the other hand, partial domain spaces are geographically set without regard to the communication protocol layers, and the network components are grouped in these partial domain units. In the present invention, an independent partial domain space may be allocated for the circuits interconnecting the networking equipment units and a plurality of connecting circuits included in a partial domain space are grouped.

In the example of FIG. 9, for example, a partial domain group 701 including area A is comprised of area A 801 which is a component belonging to the area layer, router 804 and ATM switch 803 which are components belonging to the physical layer, and router 804 which is a component also belonging to the IP layer. A partial domain group 704 including subnet A that represents the circuit interconnecting area A and area B is comprised of a physical circuit 831 which is a component belonging to the area layer 601 and the physical layer 602 and a logical circuit 834 which is a component belonging to the IP layer 603.

In the present invention, interconnections of network components are defined by describing the connection paths between the interconnected components without regard to the above layers. For example, for the physical circuit 841 shown on the area layer 601, both its connection to area A 801 on the same layer and its connection to area A 805 on the IP layer 603 are defined in the data file. The definition for interconnections of network components is described in the network topology data XML file (for example, file name: foo.xml) stored in the database 2.

In the present invention, interlayer relation is defined for specific network components (for example, area and networking equipment units) belonging to different layer spaces. In FIG. 9, the router 804 belongs to both the physical layer 602 and the IP layer 603. Because this router is the same equipment in the real network, the correspondence of the router 804 belonging to the physical layer 602 to the router 804 belonging to the IP layer 603 is defined as an interlayer relation in the data file.

The path A, which is drawn with a solid line on the physical layer 602, formed by ATM switch 803, physical circuit 841, ATM switch 823, physical circuit 851, and ATM switch 813 corresponds to the subnet A 834 belonging to the IP layer 603. Thus, this correspondence is defined as an interlayer relation in the data file. Such a definition of interlayer relation is also described in the above XML file (foo.xml) along with the above definition for interconnections of network components.

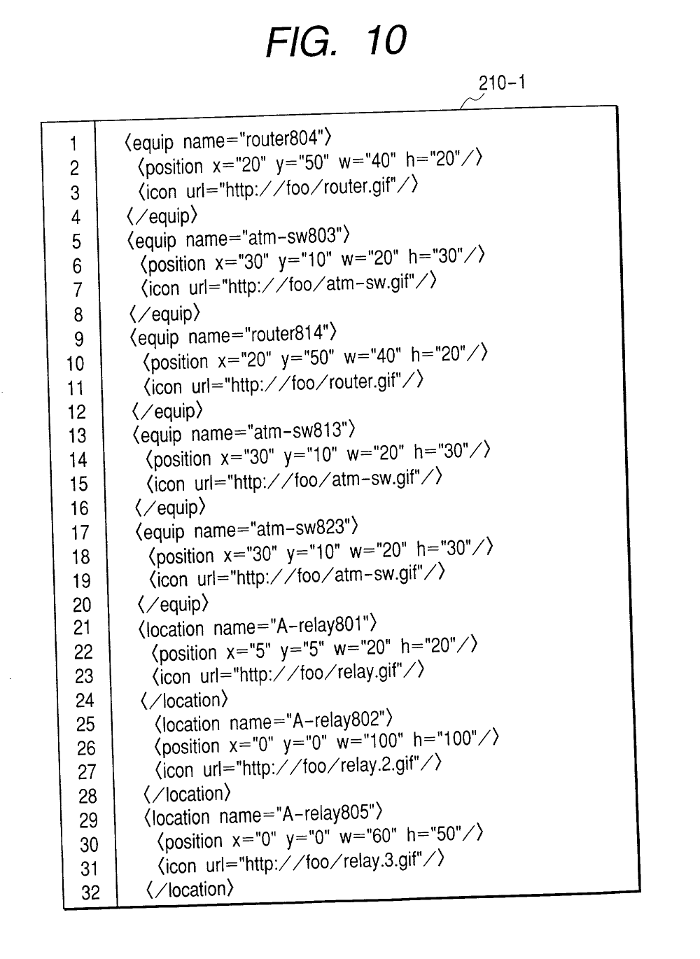

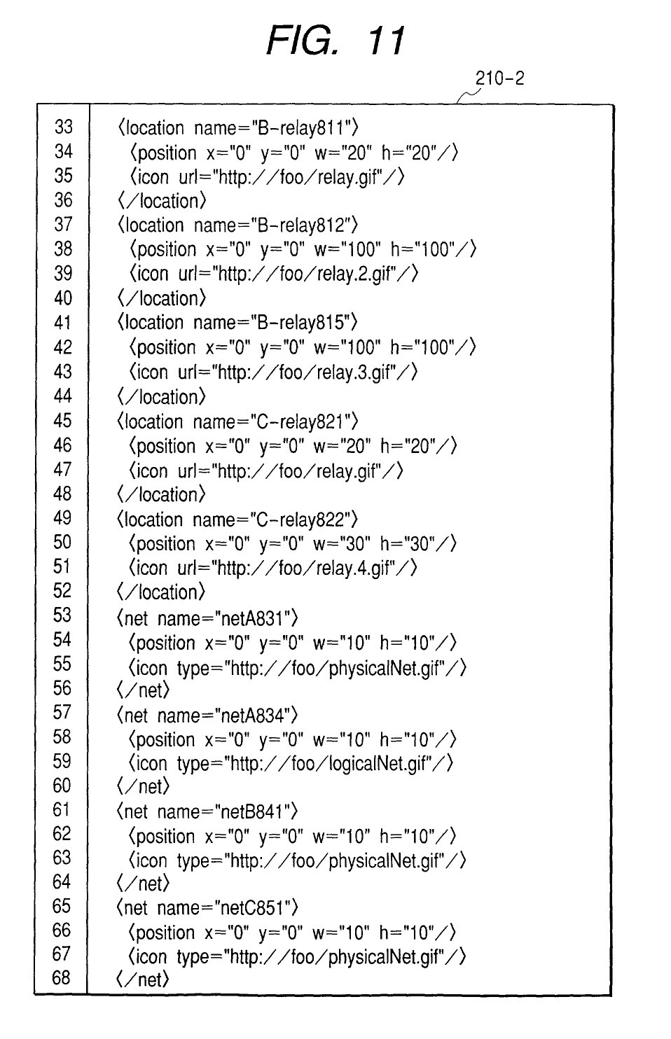

FIGS. 10 to 15 show exemplary descriptions contained in the main part of the XML file stored in the database. FIGS. 10 and 11 show exemplary descriptions of communication network components definitions 210 (210-1, 210-2) excerpted from the XML file (foo.xml). The description from tag <equip> to tag </equip> is definition data for one network equipment. The description from tag <location> to tag </location> is definition data for one area. The description from tag <net> to tag </net> is definition data for one circuit. For each component definition, the component name and its symbol figure and position on the schematic are preferably described.

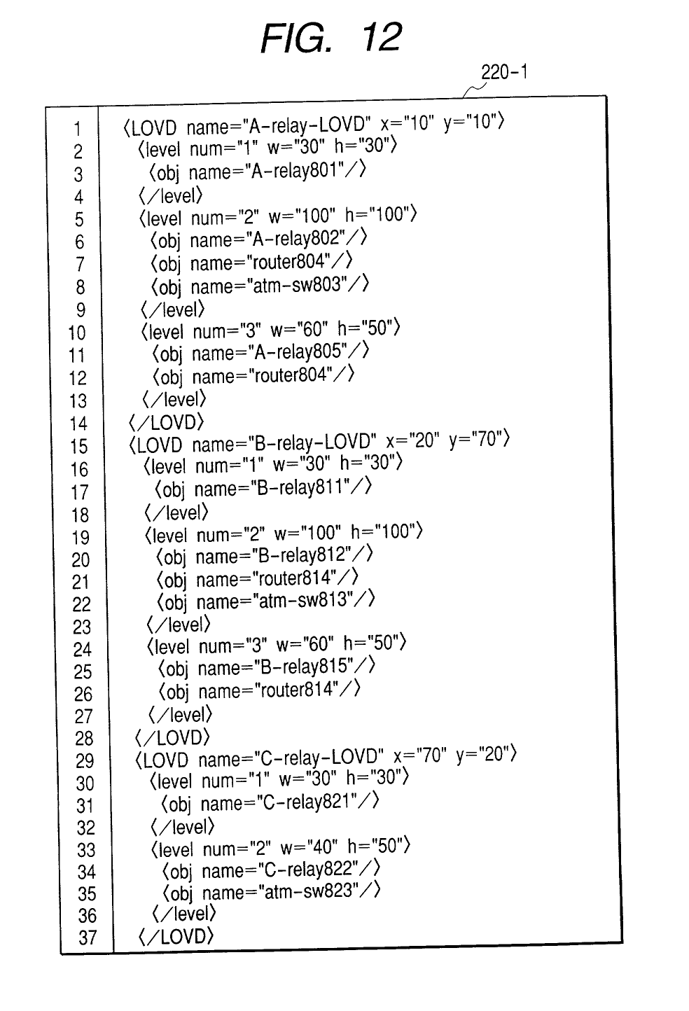

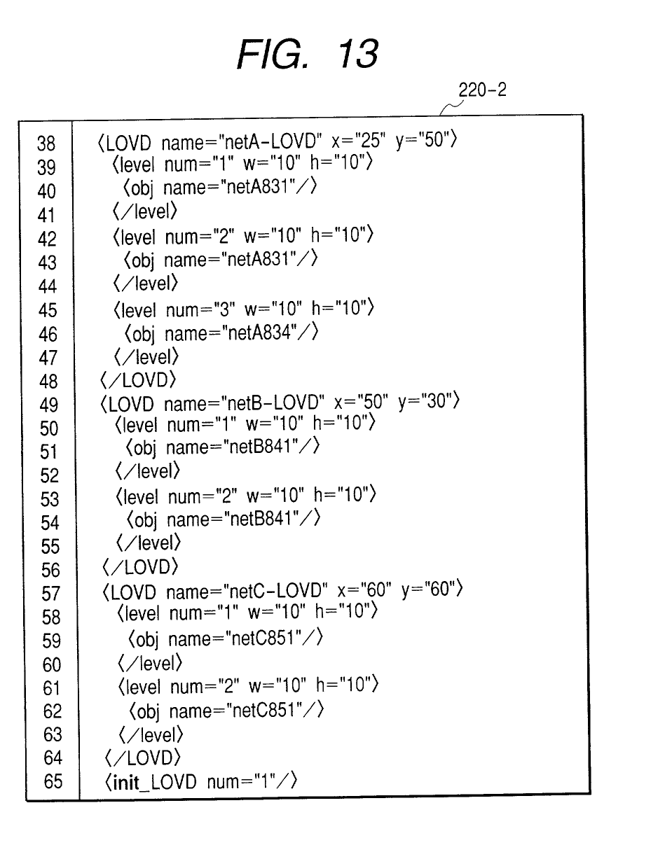

FIGS. 12 and 13 show exemplary descriptions of partial domain management data definitions 220 (220-1, 220-2) excerpted from the XML file (foo.xml). In the following explanation, the partial domain management data definitions will be referred to as “Layer of View Domain” (“LOVD”) instance definitions. The description from tag <LOVD> to tag </LOVD> is one LOVD instance data.

LOVD instances are defined in order to group the components in partial domain space units and select components to be visualized within each partial domain. For each LOVD instance, the partial domain name, the names of the components within the domain, and the domain size are described separately by layer. The LOVD instances are useful for view layer change in the partial domain selected by the user at the terminal, which will be explained in more detail below.

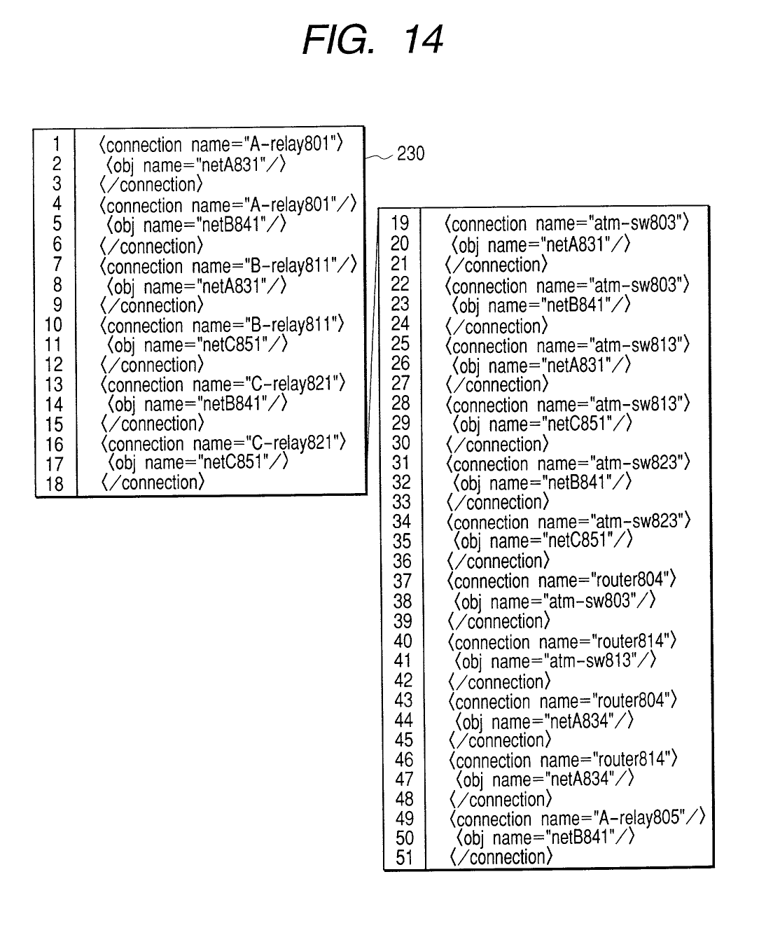

FIG. 14 shows exemplary descriptions of network component interconnection definitions 230 excerpted from the XML file (foo.xml). The description from tag <connection> to tag </connection> is a definition of one interconnection. For example, the first description of this definition means that view instance A-relay 801 representing area A 801 in FIG. 9 connects to view instance netA831 representing the physical circuit 831.

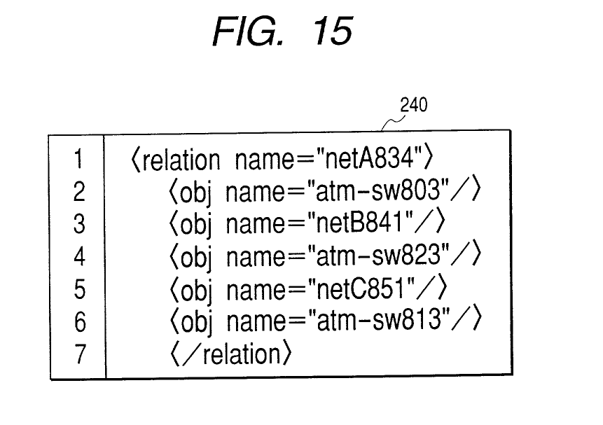

FIG. 15 shows exemplary descriptions of definitions of specific components interlayer relation 240 excerpted from the XML file (foo.xml). A description from tag <relation> to tag </relation> is a definition of one interlayer relation. For example, the first description of this definition means that view instance netA834 representing the subnet A 834 in FIG. 9 has interlayer relation to view instance atm-sw803 representing the ATM switch 803, view instance netB841 representing the physical circuit 841, view instance atm-sw823 representing the ATM switch 823, view instance netC851 representing the physical circuit 851, and view instance atm-sw813 representing the ATM switch 813.

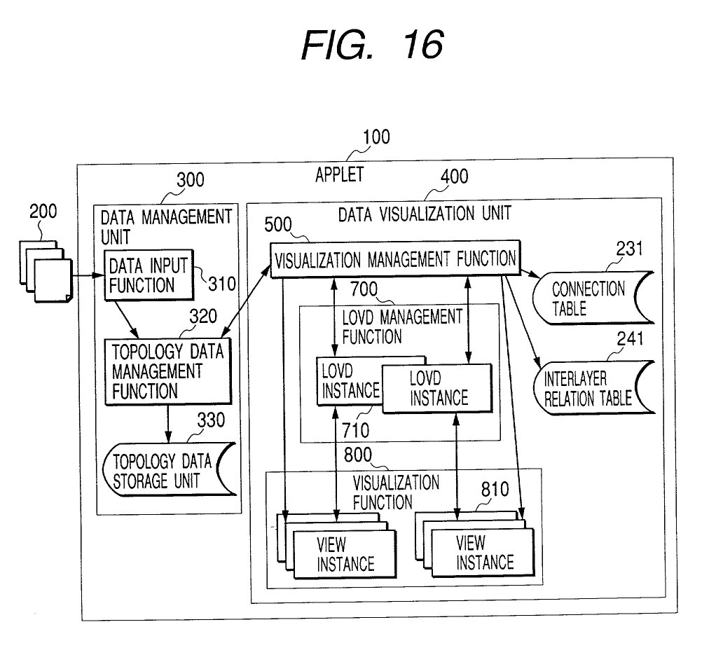

FIG. 16 shows the structure of the JAVA applet (the “applet”) 100 that is activated (either from a disk on the terminal or from a remote computer such as the server) on the terminal 3. The applet 100 preferably comprises a data management unit 300 and a data visualization unit 400. The data management unit 300 is comprised of a data input function 310 for reading the XML file 200 containing the descriptions of network topology data, a topology data storage unit 330 for storing the read network topology data, and a topology data management function 320 that controls the topology data storage unit 330.

The data visualization unit 400 is comprised of a visualization management function 500 that performs overall control of data visualization, an LOVD management function 700 that works for view layer change per partial domain selected by the terminal user, and a visualization function 800 that actually displays the objects of network components on the screen. The LOVD management function 700 controls a plurality of LOVD instances 710, each generated for each partial domain. The visualization function 800 controls view instances 810, each generated for each object. The visualization management function 500 analyzes the XML file 200 received from the server 1 and generates the above LOVD instances 710 and view instances 810. Moreover, it creates a connection table 231 and an interlayer relation table 241.

The applet is activated from the above-mentioned HTML file for visualization in which the XML file name, for example “foo.xml,” is also described. In the XML file, network topology data to be processed by the applet 100 is described.

The data input function 310 reads the XML file acquired by specifying the above file name and converts this file into a format suitable for internal processing, for example, a Document Object Model (DOM) format of element structures in the tree structure. Then, the file is stored into the topology data storage unit 330 via the topology data management function 320. The topology data management function 320 notifies the visualization management function 500 of the data visualization unit 400 of the file name (foo.xml) as well as stores the file of network topology data into the topology data storage unit 330.

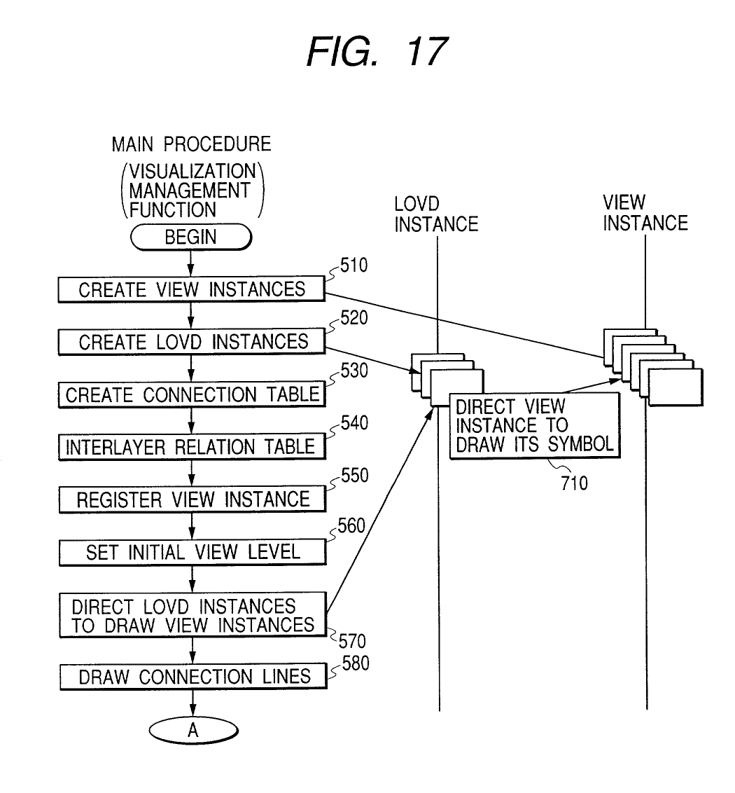

The visualization management function 500 reads necessary data from the topology data file (foo.xml) existing in the data management unit 300 and displays the network topology data on the terminal screen according to a flowchart which is shown in FIG. 17.

First, the visualization management function 500 creates view instances corresponding to the components defined in the descriptions of components definitions (FIGS. 10 and 11) within the XML file (foo.xml) (step 510). For each view instance thus created, the instance name as described in the components definitions, relative coordinates (which will be explained below), width, height, and the file name of its icon are preferably set. For example, a view instance created from the first component definition in FIG. 10 has the instance name “router 804,” the file name of its icon “router.gif,” relative coordinates “20, 50,” and width and height “40, 20.” This instance corresponds to the router 804 shown in FIG. 9.

Next, the visualization management function 500 creates LOVD instances corresponding to the partial domains shown in FIG. 9, according to the descriptions of LOVD instance definitions (FIGS, 12 and 13) within the XML file (foo.xml) (step 520). The LOVD instances are for management of view instances in the partial domain aspect, which will be explained below. For each LOVD instance thus created, the instance name 221 as described in the LOVD instance definitions and absolute coordinates 222 are set, as will be shown in FIG. 20. The absolute coordinates mean the position of the LOVD instance on the schematic from the origin coordinates (0, 0) on the display screen (or window). For example, an LOVD instance created from the first definition in FIG. 12 is given “A-relay-LOVD” as the instance name 221 and “10, 10” as the absolute coordinates 222.

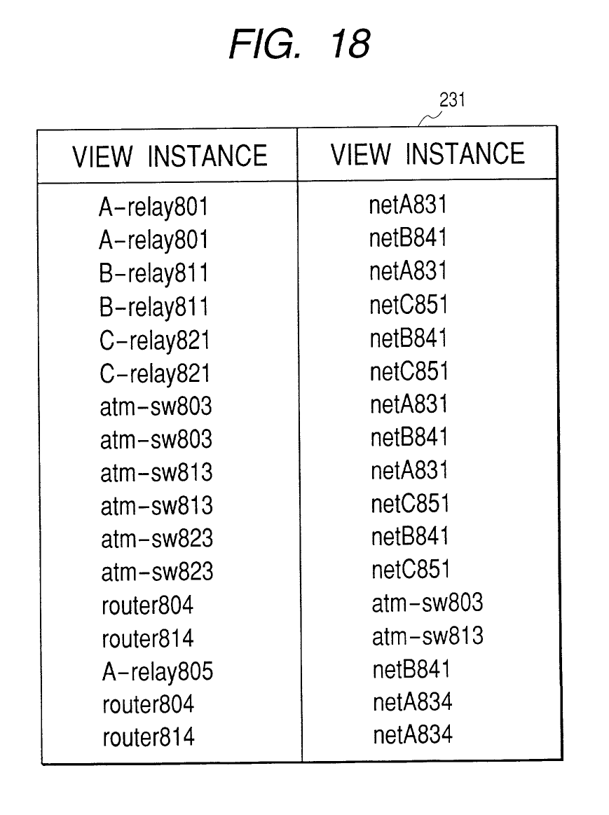

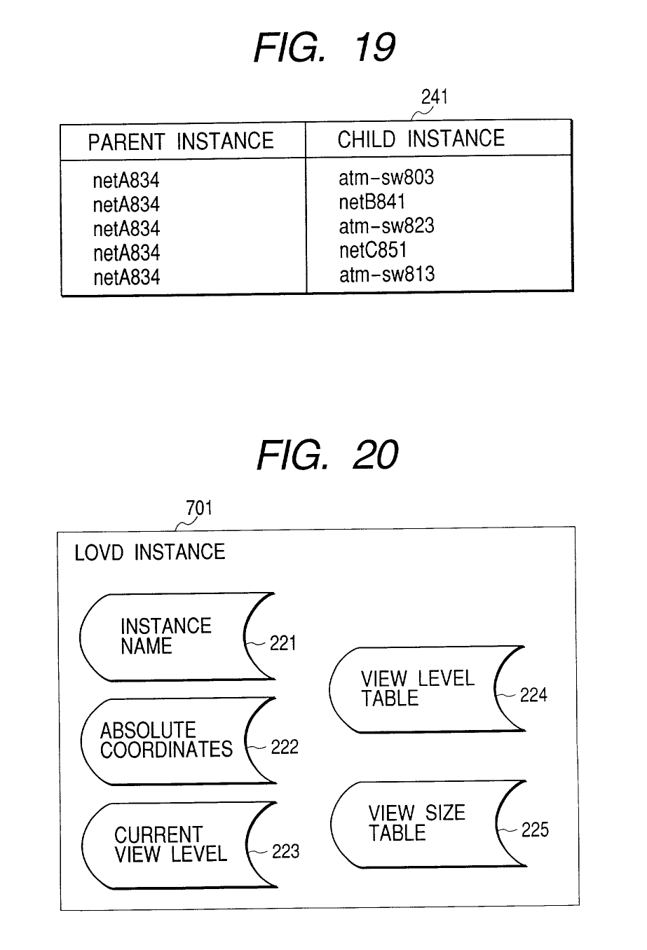

The visualization management function 500 reads the descriptions of components interconnection definitions (FIG. 14) from the XML file (foo.xml) and creates a connection table 231 which is shown in FIG. 18 (step 530). Then, the function 500 reads the descriptions of interlayer relation definitions, an example of which is shown in FIG. 15, and creates a specific components interlayer relation table 241 as shown in FIG. 19 (step 540).

In the specific components interlayer relation table 241, parent and child instances are defined. If a request for LOVD change occurs with respect to an LOVD instance that controls a parent instance, the LOVD change processing has an effect on the LOVD instance(s) that controls its child instances. However, this is not the case for inverse relation, i.e., from child to parent. By way of example, with respect to the specific components interlayer relation definitions shown in FIG. 15, the view instance “netA834” is a parent instance and the view instances “atm-sw803,” “netB841,” “atm-sw823,” “netC851,” and “atm-sw813” are child instances.

After completing these steps, the visualization management function 500 registers the view instances belonging to each partial domain with the LOVD instances (step 550). Registering the view instances with the LOVD instances means that a view level table 224 and a view size table 225 may be created per LOVD instance and added to the LOVD instance as shown in FIG. 20.

The view level table 224 is created according to the LOVD view levels specified in the descriptions from tag <level> to tag </level> in the LOVD instance definition examples shown in FIGS. 12 and 13. An example is given with reference to the first LOVD instance “A-relay-LOVD” (corresponding to group 701 in FIG. 9) in the LOVD instance definition examples shown in FIG. 12. On its descriptive lines, A-relay801 is defined as a view instance of level 1 (level num=1), A-relay802, router804, and atm-sw803 (which are area A 802, router 804, and ATM switch 803 on the physical layer 602) are defined as view instances of level 2 (level num=2), and A-relay805 and router 804 (which are area A 805 and router 804 on the IP layer 603) are defined as view instances of level 3 (level num=3).

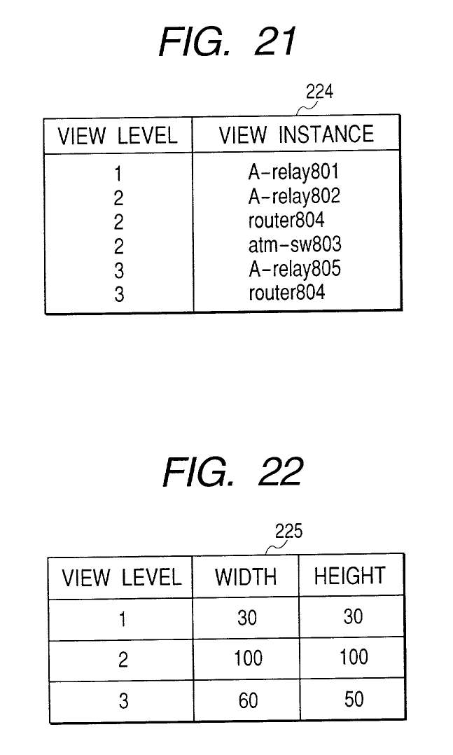

For the LOVD instance “A-relay-LOVD,” therefore, the view level table 224 is created, having exemplary contents which are shown in FIG. 21. According to this table, view level management is performed for the network components within the partial domain group 701. For other LOVD instances, the view level table is created, according to the descriptions of LOVD instance definitions, in the same way as described above.

In the view size table 225, partial domain width and height per view level are specified. By way of example, reference is made to the LOVD instance “A-relay-LOVD” in the LOVD instance definition examples shown in FIG. 12. On its descriptive lines, “<level num=“1” w=“30” h=“30”>, <level num=“2” w=“100” h=“100”>, and <level num=“3” w=“60” h=“50”> are specified. Thus, the view size table 225 is created containing exemplary values that will be shown in FIG. 22 and added to the LOVD instance “A-relay-LOVD.” For other LOVD instances, the view size table 225 is created, according to the descriptions of LOVD instance definitions, in the same way as described above.

Thereafter, the visualization management function 500 sets an initial view level for all LOVD instances (step 560). The initial view level is specified within the descriptions of LOVD instance definitions. For example, according to the value of num “1” following the <init_LOVD> tag on the last descriptive line in FIG. 13, the view level for all LOVD instances is set at 1. This initial level is set as “current view level” 223 shown in FIG. 20, and all LOVD instances display the view instances appropriate to the initial view level on the initial screen on the terminal.

The visualization management function 500 directs all LOVD instances to display the view instances on the window (step 570). Being directed to do so, each LOVD instance searches the view level table 224 and retrieves the view instances (to be displayed) of view level matching with the current view level 223. The function 500 notifies the view instances to be displayed in the visualization function 800 of the absolute coordinates 222 (directs each of the view instances to draw its symbol (icon) 710).

When each view instance is directed to draw its symbol (icon), it adds the absolute coordinates it was notified to the relative coordinates it has (its position on the schematic from the absolute coordinates as the origin). With the thus-obtained coordinates determining its position on the schematic, the view instance displays its icon image in place within the partial domain with preset width and height. Using again the above-described example of the LOVD instance “A-relay-LOVD” (partial domain group 701), the current view level 223 is “1” and the absolute coordinates “10, 10” are set for this LOVD instance.

From the view level table 224 in FIG. 21 added to the LOVD instance “A-relay-LOVD,” a view instance of level 1 is A-relay801 (area A 801 in FIG. 9), and its relative coordinates are (5, 5) as specified on the 22nd line in FIG. 10. Hence, the position of the view instance A-relay801 on the schematic is coordinates (10, 10)+(5, 5)=(15, 15). Thus, the symbol (icon) image (relay.gif—which may exist on the terminal 3 or the server 1) of the view instance A-relay801 is displayed at the coordinates (15, 15) within the domain with width=20 and height=20 on the display screen (window).

As described above, in accordance with the present invention, the network components are grouped into the LOVD instances, each defined per partial domain, and the network components within the partial domain are classified by layer and controlled by one LOVD instance, so that view layer change will be enabled for each partial domain. Thus, this invention preferably enables visualizing a specific partial domain (LOVD instance) on a certain layer that is different from the layer of other domains on the same schematic. In other words, the invention enables visualizing a network topology schematic comprising a plurality of partial domains of different view layers on the same display screen (window).

Following the above step of directing the LOVD instances to draw view instances, the visualization management function 500 preferably draws connection lines between view instances (step 580). The connection lines between view instances which are to be drawn are determined with reference to the connection table 231 (FIG. 18) created in the step 530. For the interconnected view instances registered and listed in the connection table 231, the visualization management function 500 judges whether view instances in pairs are both currently displayed and draws a solid line between the view instances in pairs that are displayed.

The function 500 preferably sequentially checks all view instance pairs listed in the connection table 231 in FIG. 18. If, for example, the first view instance pair A-relay801 and netA831 are both currently displayed, the function 500 draws a connection line (e.g., a solid line) between A-relay801 and netA831. If either of the pair is not displayed (in a non-visualized state), the function 500 checks the next view instance pair A-relay801 and netB841 and repeats the same processing.

By the above-described processing of the XML file data executed by the applet 100, the network topology data in the area selected by the user and on the selected layer is displayed on the WWW browser.

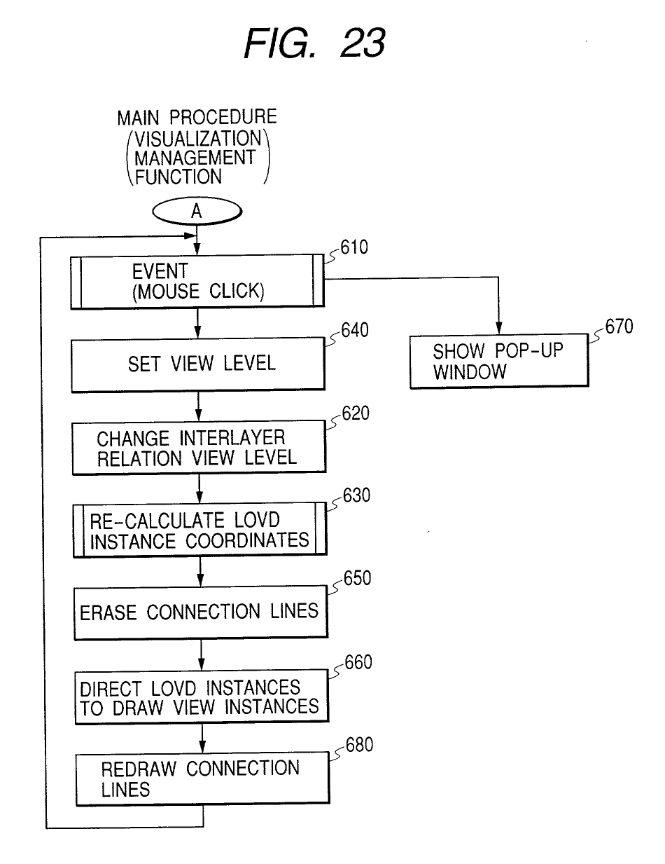

FIG. 23 illustrates how the visualization management function 500 operates after completing the steps illustrated in the flowchart of FIG. 17. Assume that the schematic state shown in FIG. 4 changes to the state shown in FIG. 5 in response to user operation. Because the size of the visualized symbol of area A 801 on the physical layer 602 differs from that on the area layer 601, there is a possibility that the area A 801 symbol will overlap with another component symbol when displayed on the physical layer. Therefore, when the view layer of area 801 changes from the area layer to the physical layer, in order to avoid the overlap of displayed symbols, the coordinates of the existing LOVD view instances should be modified so as to be harmonized with other view instances that newly joins the schematic (i.e., the displayed images should be shifted).

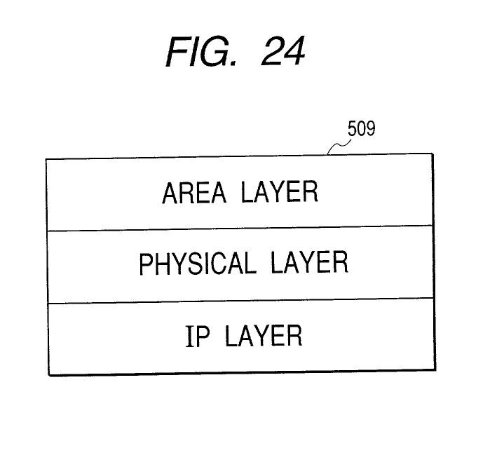

The visualization management function 500 awaits an event of input from the user. When the user selects (clicks on with a mouse) a view instance (icon) controlled by any LOVD instance (step 610), the function 500 shows a pop-up window 509, for example the one shown in FIG. 24, allowing the user to select a view level of the LOVD instance (step 670). Here, it is assumed that the user selected a view instance A-relay801 (area A 801 in FIG. 4) and then selected a physical layer (view level 2) on the pop-up window 509.

The visualization management function 500 changes the view level 223 of the A-relay-LOVD instance over the user-selected view instance A-relay801 to a new view level 2 (step 640). After changing the interlayer relation view level (step 620), which will be explained below, the function 500 recalculates the absolute coordinates of the LOVD instance (step 630).

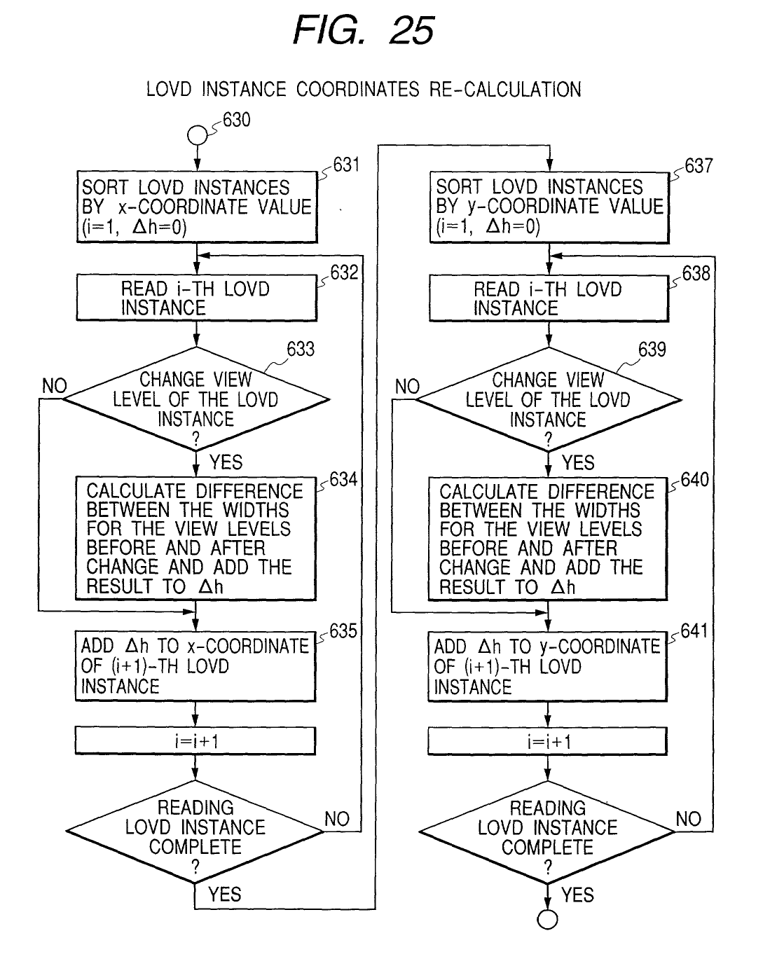

One exemplary procedure for recalculating the absolute coordinates of the LOVD instance is shown in FIG. 25. The visualization management function 500 sorts all LOVD instances by x-coordinate value in ascending order starting with the one with the smallest x-coordinate value of the absolute coordinates 222 (step 631). The function 500 preferably reads the first and following LOVD instance sequentially (step 632). The function 500 determines whether the read LOVD instance is the object of the user's request for view level change (step 633). If the LOVD instance is requested, the function 500 refers to the view size table 225 attached to it (shown in FIG. 22) calculates the difference between the view domain widths before and after the view level change, and adds the result to variable Ah (step 634). For the assumed example, the view layer of the A-relay-LOVD instance changes from the area layer (view level 1) to the physical layer (view level 2), and consequently the view domain width changes from 30 to 100 with a difference (increased width) Δh of 70.

Next, the function 500 adds the value of the variable Δh to the absolute x-coordinate value 222 of the LOVD instance which has the next greater x-coordinate value than the specified LOVD instance A-relay-LOVD (step 635) The function 500 processing returns to the step 632. By repeating the same processing for all LOVD instances arranged in ascending order of x-coordinate values, the absolute x-coordinate values of other LOVD instances, which are greater than that of the LOVD instance over the selected view instance A-relay801, are shifted by the value of Δh (i.e., every instance that has a higher x-coordinate than A-relay801 is shifted out of the way). For the LOVD instances of the present example, the x-coordinate value of B-relay-LOVD changes from 20 to 90, that of netA-LOVD changes from 25 to 95, that of netB-LOVD changes from 50 to 120, that of netC-LOVD changes from 60 to 130, and that of C-relay-LOVD changes from 70 to 140.

The function 500 executes further processing (steps 637 to 641) for the y-coordinate values of the LOVD instances in the same way as for the x-coordinate values. By this processing, the difference in height Δh of the view domain of the A-relay-LOVD instance due to the view level change is calculated, and the absolute y-coordinate values of other LOVD instances (which have a greater y-coordinate value than that of the A-relay-LOVD instance) are shifted by the value of Δh. In the present example, the difference (increase) in height Δh on the y-coordinate is also 70. Consequently, for the LOVD instances whose y-coordinate value is greater than that of the A-relay-LOVD instance, the y-coordinate value of C-relay-LOVD changes from 20 to 90, that of netB-LOVD changes from 30 to 100, that of netA-LOVD changes from 50 to 120, that of netC-LOVD changes from 60 to 130, and that of B-relay-LOVD changes from 70 to 140.

By recalculating the absolute coordinates of other LOVD instances in this way so as to be harmonized with the symbol size change due to view level change, overlap of adjacent symbols or excessive gaps between adjacent symbols (when the new view level has a lower width than the present view level) can be avoided when expansion or contraction of the symbol view domain for the object of view level change takes place.

Upon the completion of the above-described coordinates recalculation, the visualization management function 500 preferably erases the drawn connection lines between the view instances (step 650). Then, the function 500 directs the LOVD instances to draw view instances (step 660) and redraws the connection lines (step 680). The same processing as in the steps 570 and 580 in FIG. 17 is carried out. Consequently, a topology schematic display image, for example, the one shown in FIG. 5 can be obtained, where the visualization of area A selected by the user is converted to the one in which the router 804 and the ATM switch 803 are shown in the topology on the physical layer. Furthermore, the positions of area B and area C connected to the area A are modified (shifted) so as to be harmonized with the view size change of the area A.

When the schematic of FIG. 4 is shown, if the user selects (clicks with a mouse) area A and selects an IP layer to which the view level is to change, the symbols of area A 805 and router 804 are displayed as shown in FIG. 6. At the same time, the area A 805 has physical circuits 831 and 841 as the connection paths to the outside as shown in FIG. 5. In this state, if the user also selects area B 811 and selects an IP layer to which the view level is to change on the schematic shown in FIG. 4, the LOVD instance 704 erases the physical circuit 831 and adds the subnet A 834 instead, as shown in FIG. 6, because the router 804 and the newly displayed router 814 are interconnected via the subnet A 834.

Interlayer relation view level change processing (step 620) mentioned in the flowchart of FIG. 23 will now be explained. The purpose of the interlayer relation view level change processing is to visualize specific components, that have been related with each other in advance as components that correspond to each other on different layers, in special appearance (e.g., bold lines or a different color) so that the user can easily understand the correspondence between the components visualized before and after view level change.

This procedure is preferably carried out by using the specific components interlayer relation table 241 created in the step 540. For example, assume that the user selects (mouse clicks) the subnet A 834 on the schematic display image shown in FIG. 6 and selects a physical layer to which the view level is to change. In this case, the view instance netA834 is detected in the step 610 in FIG. 23 and the view level of the LOVD instance netA-LOVD to which the netA834 view instance belongs is set at “2” which is the physical layer view level in the step 640.

In the interlayer relation view level change processing (step 620), the visualization management function 500 preferably searches the specific components interlayer relation table 241 to look up the netA834 view instance selected by the user and checks whether this instance is registered as a parent instance. In this case, it is found that the netA834 view instance is registered as a parent instance with child view instances atm-sw803, netB841, atm-sw823, netC851, and atm-sw813. Then, the function 500 scans the descriptions of the A-relay-LOVD, netB-LOVD, B-relay-LOVD, netC-LOVD, and C-relay-LOVD instances that respectively control the above child instances and changes the view level 223 of the LOVD instances to “2.”

After executing the coordinates recalculation in the step 630, the function 500 changes the visualization of the netA-LOVD, A-relay-LOVD, netB-LOVD, B-relay-LOVD, netC-LOVD, and C-relay-LOVD instances in accordance with the changed view level in the same way as in the above-described example. At this time, the visualization management function 500 directs the LOVD instances to draw the child view instances (atm-sw803, netB841, atm-sw823, netC851, and atm-sw813) in accordance with the changed view level in a different style from other components on the schematic. For example, they may be drawn with bold lines or a contrasting color. Consequently, the relation of these child instances to their parent instance visualized on the image prior to the change becomes easy to understand.

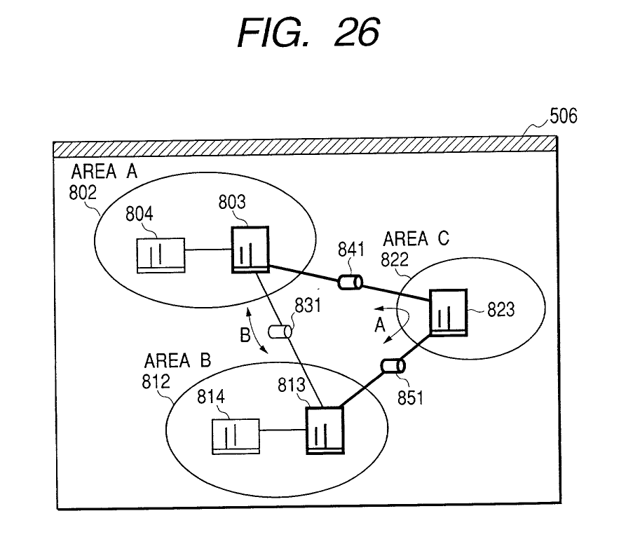

In this way, a schematic display image can be obtained, for example, as is shown in FIG. 26, where the components, ATM switch 803, physical circuit 841, ATM switch 823, physical circuit 851, and ATM switch 813, show in bold. Looking at the paths formed by the bold components, the user can promptly understand their correspondence to the subnet A 834 selected on the preceding image (FIG. 6).

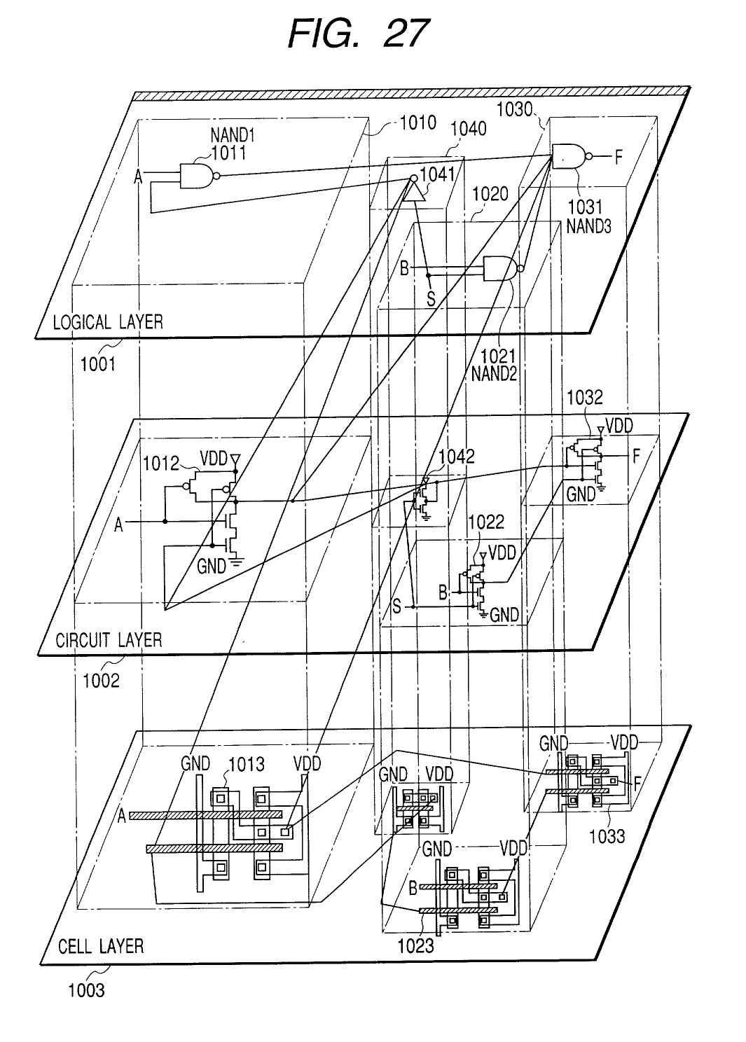

Next, as an additional exemplary embodiment, a system for visualizing schematics from electronic circuit data to which the present invention is applied, will be explained with reference to FIGS. 27 to 30.

In the present embodiment, as is shown in FIG. 27, electronic circuit configuration data is comprised of a logical layer (logical level) 1001, circuit layer (circuit level) 1002, and cell layer (cell level) 1003 of semiconductor LSI. The electronic circuit schematic on the logical level comprises NAND elements 1011, 1021, and 1031, an inverter 1041, and wiring interconnecting these elements. Circuit configuration data on the circuit layer 1002 and cell layer 1003 are prepared for the components matching the NAND elements and inverter on the logical layer 1001 schematic.

As is the case in the above-described embodiment for visualizing network topology schematics, in the present embodiment, by controlling the view instances per level (layer) in partial domain space units, the view level of a specific circuit component visualized on the display screen can be changed to another view level.

Specifically, in a partial domain (LOVD instance) 1010, view data for NAND 1011 on the logical layer, circuit 1012 on the circuit layer, and cell 1013 on the cell layer is managed. For other partial domains 1020, 1030, and 1040, similarly, their LOVD instances manage view data for components of a plurality of layers. Component-to-component connections are managed by the connection table and interconnection of components of different layers is managed by the interlayer relation table as required.

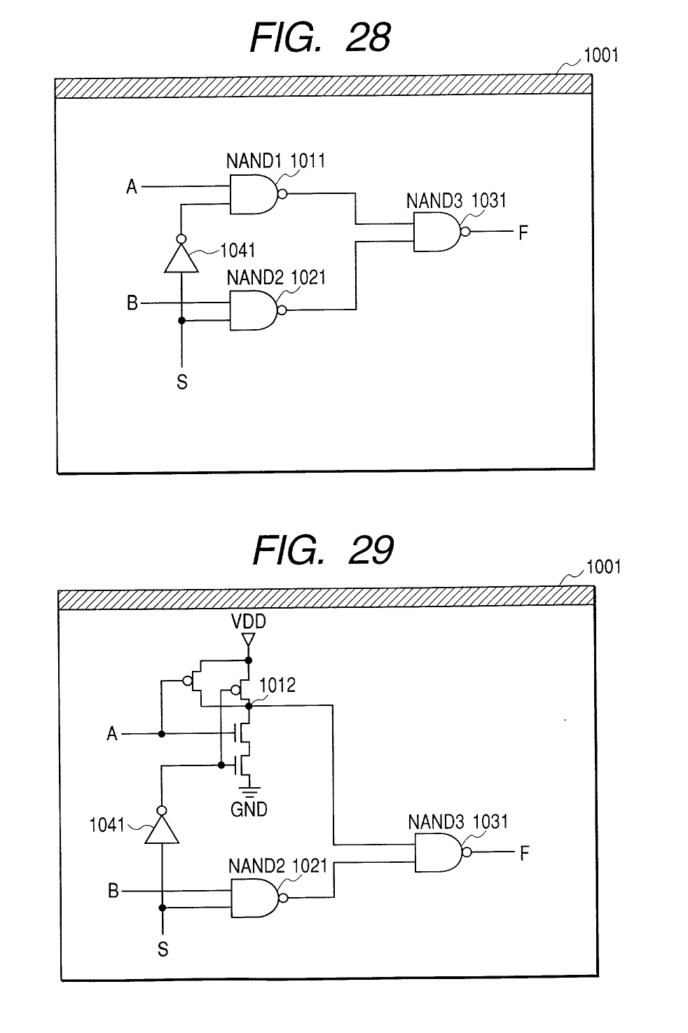

FIG. 28 shows a complete electronic circuit schematic display image visualized on the logical level 1001. FIG. 29 shows a schematic display image if NAND 1011 is selected on the display image of FIG. 28 and view level change to the circuit level is ordered. When the LOVD instance 1010 that controls the NAND 1011 is directed by the visualization management function 500 to make a view level change to the physical layer, it preferably erases the NAND 1011 displayed on the preceding display and displays its symbol 1012 on the circuit layer.

According to the connection table, the visualization management function 500 changes the displayed connection lines. Because connection between the circuit 1012 and NAND 1031 and connection between the circuit 1012 and inverter 1041 are predefined on FIG. 27 and the NAND 1031 and inverter 1041 have already been put in the displayed state, connection lines from the newly displayed circuit 1012 to the NAND 1031 and the inverter 1041 are drawn.

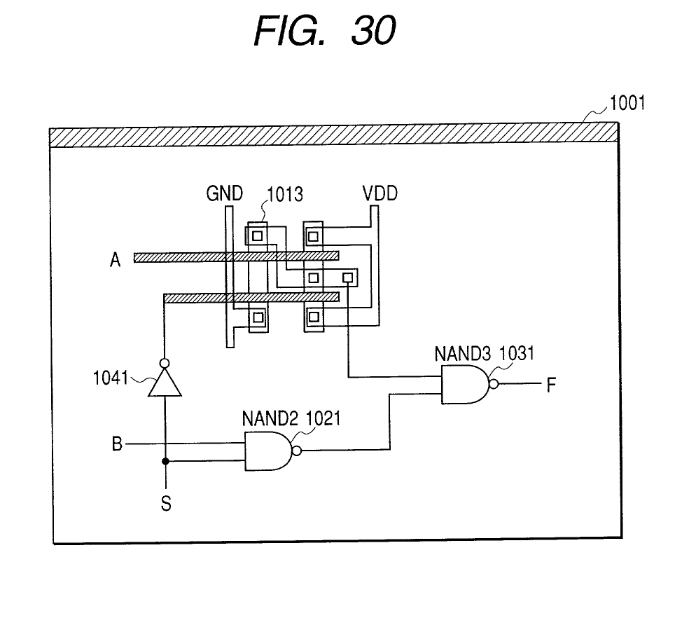

FIG. 30 shows a schematic display if NAND 1011 is selected on the display image of FIG. 28 and view level change to the cell level is requested. When the LOVD instance 1010 that controls the NAND 1011 is directed by the visualization management function 500 to make a view level change to the cell layer, it erases the NAND 1011 visualized on the preceding display and visualizes its cell 1013. According to the connection table, the visualization management function 500 draws connection lines from the cell 1013 to other components. Because connection between the cell 1013 and NAND 1031 and connection between the cell 1013 and inverter 1041 are predefined on FIG. 27 and the NAND 1031 and inverter 1041 have already been put in the displayed state, connection lines from the newly displayed cell 1013 to the NAND 1031 and the inverter 1041 are drawn.

In accordance with the foregoing embodiments, the network topology schematic space consisting of a plurality of layers is divided into a plurality of partial domains in accordance with the arrangement of the network components. For each partial domain, the network components to be visualized within the domain are predefined per layer (LOVD instance definition). Thereby, when the user selects a specific partial domain and orders a view layer change to another layer, the network topology schematic on the user-selected layer can be displayed, based on the definitions of the components to be controlled in the selected partial domain.

Furthermore, the coordinates of each partial domain on the schematic are predefined. Domain size per view layer required to accommodate newly displayed components by view layer change is also predefined. Thereby, judgment whether the domain size required to accommodate newly displayed components by view layer change is different from the domain size on the preceding schematic display. If the domain size for the newly selected level is different from the preceding domain size, the positions of other partial domains on the display screen, affected by the newly displayed components are modified (e.g., shifted) so that view layer change can be performed with adequate gaps being maintained between the components.

Moreover, as explained in the foregoing embodiments, interconnections of the network components to be visualized in the network topology schematic space consisting of a plurality of layers are predefined as discrete component-to-component links without regard to the layers to which the components belong, according to the connections to be displayed on the monitor or screen. Thereby, even when view layer change takes place for a specific partial domain in accordance with the user input, the newly displayed components can properly connect with the existing components.

Furthermore, distinct correspondence of a specific component on one layer to one or more components included in another layer is predefined as interlayer relation. Thereby, when the specific component is replaced by a group of new components after view layer change, the new components corresponding to the specific component can be displayed in user-distinguishable appearance (e.g., bold).

In accordance with the present invention, view layer change may be performed in partial domain units without depending on the hierarchical order of the layers, which dependency restricts the conventional methods. In addition to the application to communication network topology as well as electronic device wiring and logic check as explained in the foregoing embodiments, the present invention can be useful for other applications involving components-basis view level change.

As will be evident from the description herein, as compared with the conventional system for visualizing multi-layer topology schematics from topology data wherein schematics of layers are defined in parent-child relationship or order-based relationship in the tree structure, the system in accordance with the present invention preferably enables more flexible view layer changing for the view components without being restricted by hierarchical relationship. This system preferably also enables visualizing schematic images with one or more of the following features: view layer change for an optional component selected, view layer change with connection lines between network components specified, and easily recognizable correspondence between new and old components before and after view layer change.

The invention may be embodied in other specific forms without departing from the spirit or characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A system for visualizing, from topology data, a multi-layer topology schematic including a plurality of view levels, said system comprising:
visualization control means; and
partial domain management units prepared for each of a plurality of partial domains defined in said topology schematic,
wherein each of said partial domain management units includes predefined components to be displayed within the partial domain and a view level associated with each component, wherein said components are defined for at least two of said plurality of view levels within the partial domain,
further wherein in response to an input by which a partial domain and a requested view level to which the currently displayed schematic is to change have been selected, said visualization control means sets said requested view level in the partial domain management unit associated with said selected partial domain, and said system displays within said selected partial domain the component belonging to said requested view level as defined in said associated partial domain management unit.

2. The system recited in claim 1, wherein each of said partial domain management units stores domain coordinate settings and domain size settings for each of said plurality of view levels, and said system displays the components of the selected partial domain and requested view level based on said domain coordinate settings and said domain size settings.

3. The system as recited in claim 2, wherein said visualization control means compares the domain size settings of the current view level and the requested view level and automatically modifies the coordinates of other partial domains to be displayed, according to the results of said comparison.

4. The system as recited in claim 3, wherein said modification includes shifting said other partial domains in the horizontal direction by an amount equal to the difference between the width of the new domain minus the width of the old domain.

5. The system as recited in claim 3, wherein said modification includes shifting said other partial domains in the vertical direction by an amount equal to the difference between the height of the new domain minus the height of the old domain.

6. The system as recited in claim 2, further comprising:
a means for storing the data of the relative coordinates at which a component is to be visualized within the partial domain and the component symbol figure for all components included in said multi-layer topology schematics.

7. The system as recited in claim 6, wherein said system displays the symbol figure corresponding to the component on said requested view level in said selected partial domain in a position determined by said relative coordinates.

8. The system as recited in claim 1, further comprising:
a component s connection table in which component-to-component connections included in said multi-layer topology schematics are defined as discrete component-to-component links independent of the view level to which each component belongs.

9. The system as recited in claim 8, wherein said visualization control means displays connection lines between a component displayed in response to said input and a component that is currently displayed and had also been displayed before said input on the display screen in accordance with said components connection table.

10. The system as recited in claim 1, further comprising:
an interlayer relation table in which distinct correspondence of a specific component on a view level to at least one component on another view level is defined.

11. The system as recited in claim 10, wherein, when a new component is displayed in place of a previous component based on said input, and said new component and said previous component have a corresponding relationship in said interlayer relation table, said visualization control means displays said new component in a characteristic visual style.

12. The system as recited in claim 10, wherein said characteristic visual style is selected from the group consisting of bold, a contrasting color, a different line thickness, a different line type, a different background color, a different background texture, blinking content, or a combination thereof.

13. A method for visualizing, from topology data, a multi-layer topology schematic including a plurality of view levels, said method to be used on a terminal device connected to a server via a network, said method comprising the steps of:
receiving multi-layer topology data wherein components or component-to-component connections may be different for each of said view levels;
creating a partial domain view level table in which components to be displayed within each level of the partial domain and the view levels of the components are defined for all partial domains set in accordance with the arrangement of components in the topology schematic;
displaying on the screen of the terminal an initial topology schematic on an initial view level in accordance with said multi-layer topology data; and
in response to user input by which a partial domain and a requested view level to which the currently displayed schematic is to change have been selected, determining which component(s) belong to said requested view level from the partial domain view level table for the selected partial domain and changing the display of said selected partial domain to that of the determined component(s).

14. The method as recited in claim 13, wherein the multi-layer topology data received from said server includes predefined domain coordinate settings and domain size settings for each of said partial domains in each of said plurality of view levels,
and wherein in response to said user input, said terminal device displays the component on the requested view level based on said domain coordinate settings and said domain size settings.

15. The method as recited in claim 13, wherein said terminal device compares said domain size settings before and after view level change and automatically modifies the coordinates of other partial domains to be displayed on the schematic, according to the results of said comparison.

16. The method as recited in claim 14, wherein the multi-layer topology data received from said server includes predefined relative coordinates at which a component is to be displayed within the partial domain and a predefined component symbol figure for each component, and said terminal device displays the symbol figure corresponding to the component on said requested view level in a position determined by said relative coordinates within said view domain.

17. The method as recited in claim 13, wherein said terminal device creates a components connection table in which component-to-component connections included in multi-layer topology schematics are defined as discrete component-to-component links independent of the view level to which each component belongs, according to the multi-layer topology data received from said server.

18. The method as recited in claim 13, wherein said terminal device creates an interlayer relation table in which distinct correspondence of a specific component on a view level to at least one component on another view level is defined, according to the multi-layer topology data received from said server.

19. A computer-executable program for performing a visualization process comprising:
the step of generating a plurality of view instances, each in which the identifier of a component, coordinates where the component is to be displayed on the schematic, and the component symbol figure are defined from given topology definition data;
the step of generating partial domain instances for all partial domains set in topology schematic space from said topology definition data, each domain instance controlling the components to be displayed in the domain per view level;
the step of generating a connection table in which component-to-component connections are defined from said topology definition data;
the step of identifying initial components for a predefined initial level specified by referring to said partial domain instances and displaying the symbol figures of the components on the display screen in accordance with the definitions of the view instances corresponding to the identified components; and
the step of displaying connection lines between the displayed components in accordance with said connection table.

20. The program according to claim 19, further comprising the step of:
in response to an external input identifying a selected partial domain and a requested view level to which the current view layer is to change, identifying component(s) by referring to the partial domain instance for said selected partial domain and displaying the symbol figure(s) of the components(s) in accordance with the definition(s) of the view instance(s) for the identified component(s).
